(19) United States
(12) Patent Application Publication
(10) Pub. No.: US 2016/0371737 A1
(43) Pub. Date: Dec. 22, 2016

(54) PERSONALIZED AND CONTEXTUAL NOTIFICATIONS OF CONTENT RELEASES

(71) Applicant: Google Inc., Mountain View, CA (US)

(72) Inventors: Justin Lewis, Marina del Rey, CA (US); Michael Patrick Schneider, Venice, CA (US)

(21) Appl. No.: 14/743,232

(22) Filed: Jun. 18, 2015

(51) Int. Cl. G06Q 30/02; G06Q 50/00

(52) U.S. Cl. CPC G06Q 30/0269; G06Q 50/01

(57) ABSTRACT

In some implementations, a method for providing personalized and contextual notifications of content releases is disclosed. The method includes: receiving a request pertaining to a first content item, wherein the request is initiated by a first user; determining, using a processing device, whether the first content item is associated with a first notification of an upcoming event pertaining to a second content item, wherein the second content item is to be provided by a second user; causing the first notification to be presented to the first user in response to determining that the first content item is associated with the first notification; receiving, during a presentation of the first notification to the first user, a request initiated by the first user for a second notification of the upcoming event; and causing the second notification of the upcoming event to be presented to the first user at a later time.

### TECHNICAL FIELD

This disclosure relates to the field of content sharing platforms and, in particular, to personalized and contextual notifications of content releases.

### BACKGROUND

On the Internet, social networks allow users to connect to and share information with each other. Many social networks include a content sharing aspect that allows users to upload, view, and share content, such as video content, image content, audio content, and so on. Other users of the social network may comment on the shared content, discover new content, locate updates, and otherwise interact with the provided content. The shared content may include content from professional content creators, e.g., movie clips, TV clips, and music videos, as well as content from amateur content creators, e.g., video blogging and short original videos.

### SUMMARY

The following is a simplified summary of the disclosure in order to provide a basic understanding of some aspects of the disclosure. This summary is not an extensive overview of the disclosure. It is intended to neither identify key or critical elements of the disclosure, nor delineate any scope of the particular implementations of the disclosure or any scope of the claims. Its sole purpose is to present some concepts of the disclosure in a simplified form as a prelude to the more detailed description that is presented later.

In an aspect of the disclosure, a method includes: receiving a request pertaining to a first content item, wherein the request is initiated by a first user; determining, using a processing device, whether the first content item is associated with a first notification of an upcoming event pertaining to a second content item, wherein the second content item is to be provided by a second user; causing the first notification to be presented to the first user in response to determining that the first content item is associated with the first notification, wherein the first notification is to inform the first user that the second content item is to be provided on a content sharing platform; receiving, during a presentation of the first notification to the first user, a request initiated by the first user for a second notification of the upcoming event; and causing the second notification of the upcoming event to be presented to the first user at a later time.

In some implementations, the upcoming event includes a live stream of the second content item on the content sharing platform.

In some implementations, the upcoming event includes publishing the second content item on the content sharing platform.

In some implementations, the request pertaining to the first content item includes a request to present the first content item.

In some implementations, causing the first notification to be presented to the first user includes: causing the first content item to be presented on a first client device; and causing the first notification to be presented on a second client device.

In some implementations, the request pertaining to the first content item includes a request to present information related to the first content item.

In some implementations, the method further includes in response to determining that the first content item is associated with the first notification, determining whether a notification condition pertaining to the first notification is satisfied with respect to the first user, wherein the first notification is to be presented to the first user in response to determining that the notification condition pertaining to the first notification is satisfied with respect to the first user.

In some implementations, determining whether the notification condition pertaining to the first notification is satisfied with respect to the first user includes determining whether the first user has a predetermined interaction with content provided by the second user.

In some implementations, determining the notification condition pertaining to the first notification is satisfied with respect to the first user includes determining whether the first user has subscribed to a channel associated with the second user.

In some implementations, the method further includes: generating the first notification in response to receiving a request to share information related to the upcoming event; and associating the first notification with the first content item in response to determining that the first content item relates to the second content item.

### BRIEF DESCRIPTION OF THE DRAWINGS

The present disclosure is illustrated by way of example, and not by way of limitation, in the figures of the accompanying drawings.

FIG. 1 illustrates an example of a system architecture, in accordance with one implementation of the disclosure.

FIG. 2 is a block diagram illustrating a notification component in accordance with some implementations of the disclosure.

FIGS. 3A and 3B are examples of user interfaces for creating an upcoming event pertaining to a content item, according to some implementations of the disclosure.

FIG. 4 illustrates examples of user interfaces for providing personalized and contextual notifications of content releases, according to some implementations of the disclosure.

FIG. 5 is a flow diagram illustrating a method for creating an upcoming event pertaining to a content item by a client device, according to some implementations of the disclosure.

FIG. 6 is a flow diagram illustrating a method for creating an upcoming event pertaining to a content item by a server device, according to some implementations of the disclosure.

FIG. 7 is a flow diagram illustrating a method for providing personalized and contextual notifications of content releases by a client device, according to some implementations of the disclosure.

FIG. 8 is a flow diagram illustrating a method for providing personalized and contextual notifications of content releases by a server device, according to some implementations of the disclosure.

FIG. 9 is a block diagram illustrating an exemplary computer system, according to some implementations.

### DETAILED DESCRIPTION

Aspects and implementations of the disclosure are directed to providing personalized and contextual notifications of content releases. Implementations are described for a notification component that can provide notifications of upcoming events pertaining to content items, such as publishing a video on a content sharing platform at a future time, a live stream or broadcast of video content and/or audio content at a future time, etc.

As used herein, the term “content item” may refer to an electronic file that can be executed or loaded using software, firmware or hardware configured to present the content item to an entity. A content item may contain video content, audio content, text content, images, and/or any other content. As used herein, the term “live stream” may refer to content provided live over the Internet. In some implementations, a live steam of content can be provided once over the Internet.

Previously, content sharing platforms did not provide a solution for personalized and contextual notification of content releases. For example, in order to see if new videos are available on a conventional content sharing platform, a user might have to visit a web page hosted by the conventional content sharing platform. The conventional content sharing platform might also notify the user of the new videos that have been released. However, such notification would be provided to the user after the new videos having been released on the conventional content sharing platform. As such, these content sharing platforms do not provide user with notifications of upcoming events, such as a live stream of content that may be available once over the Internet.

Implementations of the disclosure address the above and other deficiencies by notifying users of upcoming events pertaining to content releases in a contextual manner. For example, when a user of a content sharing platform (also referred to herein as “creator user”) creates an upcoming event pertaining to a content item (e.g., a live stream of video content), the notification component can generate a preliminary notification of the upcoming event. The preliminary notification can include an indication that the content item is to be provided on the content sharing platform. The preliminary notification can include scheduling information of the upcoming event (e.g., a start time and/or an end time of the upcoming event), a description of the upcoming event, and/or any other information related to the upcoming event. The preliminary notification can include additional content, such as text, images, video, audio, etc. provided by the creator user.

The notification component can present the preliminary notification in association with content related to the content item. For example, the notification component can present the notification to another user (also referred to herein as “viewing user”) when the viewing user interacts with content associated with the creator user (e.g., watching a video uploaded by the creator user, browsing a web page associated with the creator user, etc.). In some implementations, the preliminary notification can be presented as one or more video annotations, activity feeds, user interface elements, etc. In some implementations, the preliminary notification can be presented without interrupting the viewing user's interactions with the content associated with the creator user. The notification component can also provide the viewing user with an option to receive a follow-up notification of the upcoming event. The follow-up notification can be and/or include a mobile notification, an email notification, a calendar notification, etc.

In some implementations, the notification component can provide notifications for particular content and/or particular users. For example, notifications can be provided for paid content. As another example, notifications can be provided to subscribers of a channel on a content sharing platform.

Accordingly, aspects of the present disclosure provide personalized and contextual notifications of new content releases to viewing users of a content sharing platform. Any creator user of the content sharing platform can notify their fans of upcoming content releases and such notifications can be delivered to the fan's mobile devices in a non-intrusive manner and at a contextually relevant time. Aspects of the present disclosure can also create a centralized place to view events related to channels users like.

The present disclosure often references videos for simplicity and brevity. However, the teaching of the present disclosure are applied to content items generally and can be applied to various types of content or content items, including for example, video, audio, text, images, program instructions, etc. The content items referred to herein represent viewable and/or shareable content items.

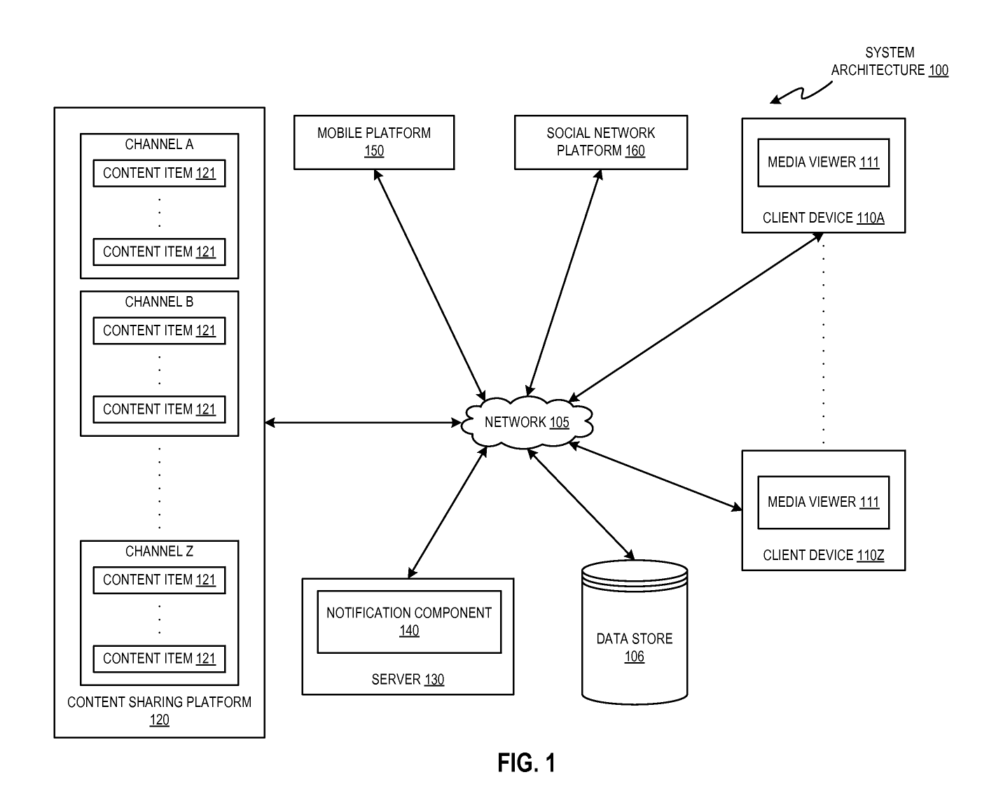

FIG. 1 illustrates an example system architecture 100, in accordance with one implementation of the disclosure, for providing personalized and contextual notifications of content releases. The system architecture 100 includes client devices 110A through 110Z, a network 105, a data store 106, a content sharing platform 120, a server 130, and a mobile platform 150. In one implementation, network 105 may include a public network (e.g., the Internet), a private network (e.g., a local area network (LAN) or wide area network (WAN)), a wired network (e.g., Ethernet network), a wireless network (e.g., an 902.11 network or a Wi-Fi network), a cellular network (e.g., a Long Term Evolution (LTE) network), routers, hubs, switches, server computers, and/or a combination thereof. In one implementation, the data store 106 may be a memory (e.g., random access memory), a cache, a drive (e.g., a hard drive), a flash drive, a database system, or another type of component or device capable of storing data. The data store 106 may also include multiple storage components (e.g., multiple drives or multiple databases) that may also span multiple computing devices (e.g., multiple server computers).

The client devices 110A through 110Z may each include computing devices such as personal computers (PCs), laptops, mobile phones, smart phones, tablet computers, netbook computers etc. In some implementations, client device 110A through 110Z may also be referred to as “user devices.” Each client device includes a media viewer 111. In one implementation, the media viewers 111 may be applications that allow users to view content, such as images, videos, web pages, documents, etc. For example, the media viewer 111 may be a web browser that can access, retrieve, present, and/or navigate content (e.g., web pages such as Hyper Text Markup Language (HTML) pages, digital media items, etc.) served by a web server. The media viewer 111 may render, display, and/or present the content (e.g., a web page, a media viewer) to a user. The media viewer 111 may also display an embedded media player (e.g., a Flash® player or an HTML5 player) that is embedded in a web page (e.g., a web page that may provide information about a product sold by an online merchant). In another example, the media viewer 111 may be a standalone application that allows users to view digital media items (e.g., digital videos, digital images, electronic books, etc.).

The media viewers 111 may be provided to the client devices 110A through 110Z by the server 130 and/or content sharing platform 120. For example, the media viewers 111 may be embedded media players that are embedded in web pages provided by the content sharing platform 120. In another example, the media viewers 111 may be applications that are downloaded from the server 130.

In general, functions described in one implementation as being performed by the content sharing platform 120 can also be performed on the client devices 110A through 110Z in other implementations if appropriate. In addition, the functionality attributed to a particular component can be performed by different or multiple components operating together. The content sharing platform 120 can also be accessed as a service provided to other systems or devices through appropriate application programming interfaces, and thus is not limited to use in websites.

In one implementation, the content sharing platform 120 may be one or more computing devices (such as a rackmount server, a router computer, a server computer, a personal computer, a mainframe computer, a laptop computer, a tablet computer, a desktop computer, etc.), data stores (e.g., hard disks, memories, databases), networks, software components, and/or hardware components that may be used to provide a user with access to media items and/or provide the media items to the user. For example, the content sharing platform 120 may allow a user to consume, upload, search for, approve of (“like”), dislike, and/or comment on media items. The content sharing platform 120 may also include a website (e.g., a webpage) that may be used to provide a user with access to the media items. Content sharing platform 120 may include any type of content delivery network providing access to content and/or media items.

The content sharing platform 120 may include multiple channels (e.g., channels A through Z). A channel can be data content available from a common source or data content having a common topic or theme. The data content can be digital content chosen by a user, digital content made available by a user, digital content uploaded by a user, digital content chosen by a content provider, digital content chosen by a broadcaster, etc. For example, a channel X can include videos Y and Z. A channel can be associated with an owner, who is a user that can perform actions on the channel.

Different activities can be associated with the channel based on the owner's actions, such as the owner making digital content available on the channel, the owner selecting (e.g., liking) digital content associated with another channel, the owner commenting on digital content associated with another channel, etc. The activities associated with the channel can be collected into an activity feed for the channel. Users, other than the owner of the channel, can subscribe to one or more channels in which they are interested. Once a user subscribes to a channel, the user can be presented with information from the channel's activity feed. An activity feed may be a list of recent activity associated with the user and occurring on the social network. If a user subscribes to multiple channels, the activity feed for each channel to which the user is subscribed can be combined into a syndicated activity feed. Information from the syndicated activity feed can be presented to the user. Although channels are described as one implementation of a content sharing platform, implementations of the disclosure are not limited to content sharing platforms that provide content items via a channel model.

Each channel may include one or more content items 121. Examples of a content item 121 can include, and are not limited to, digital video, digital movies, digital photos, digital music, website content, social media updates, electronic books (ebooks), electronic magazines, digital newspapers, digital audio books, electronic journals, web blogs, real simple syndication (RSS) feeds, electronic comic books, software applications, etc. In some implementations, content item 121 is also referred to as a media item.

A content item 121 may be consumed via the Internet and/or via a mobile device application. As used herein, “media,” “media item,” “online media item,” “digital media,” “digital media item,” “content,” and “content item” can include an electronic file that can be executed or loaded using software, firmware or hardware configured to present the digital content item to an entity. In one implementation, the content sharing platform 120 may store the content items 121 using the data store 106.

Mobile platform 150 may be and/or include one or more computing devices (e.g., servers), data stores, networks, software components, and/or hardware components that may be used to allow users to connect to, share information, and/or interact with each other using one or more mobile devices (e.g., phones, tablet computers, laptop computers, wearable computing devices, etc.) and/or any other suitable devices. For example, the mobile platform 150 may enable telephony communication, Short Message Service (SMS) messaging, Multimedia Message Service (MMS) messaging, text chat, video chat, and/or any other communication between users. The mobile platform 150 may present to a user a listing (e.g., activity feed, feed, stream, wall, etc.) of objects (e.g., posts, content items (e.g., videos, images, audios, etc.), status updates, favorability indications, tags, messages, etc.) provided by other users of the mobile platform. The mobile platform 150 may also include a content sharing aspect that allows users to upload, view, tag, share, and/or perform any other function on content, such as text content, video content, image content, audio content, etc. Other users of the mobile platform 150 may comment on the shared content, discover new content, locate updates, share content, and otherwise interact with the provided content. As will be described in further detail below, the mobile platform 150 may provide notifications of upcoming events pertaining to media content items to one or more mobile devices.

The social network platform 160 may be and/or include one or more computing devices (such as a rackmount server, a router computer, a server computer, a personal computer, a mainframe computer, a laptop computer, a tablet computer, a desktop computer, etc.), data stores (e.g., hard disks, memories, databases), networks, software components, and/or hardware components that may be used to provide a user with content sharing services. For example, as will be described in more detail further below in accordance with some implementations, the social network platform 150 may notify users of upcoming events pertaining to new content releases.

In one implementation, the content sharing platform 120 may be integrated with the mobile platform 150 and/or the social network platform 160. For example, the mobile platform 150 and/or the social network platform 160 may use the content sharing platform 120 to provide users with content sharing, content storage, content streaming, content processing, and/or any other service. In one example, a user of the mobile platform 150 and/or the social network platform 160 may upload and/or share content via the content sharing platform 120. In another implementation, the mobile platform 150 and the social network platform 160 may be separate from the content sharing platform 120.

In one implementation, the server 130 may be one or more computing devices (e.g., a rackmount server, a server computer, etc.). In one implementation, the server 130 may be included in the content sharing platform 120, the mobile platform 150, and/or the social network platform 160. In another implementation, the server 130 may be separate from one or more of the content sharing platform 120, the mobile platform 150, and the social network platform 160 but may communicate with (e.g., exchange data with) the content sharing platform 120, the mobile platform 150, and/or the social network platform 160.

The server 130 may include a notification component 140 for providing personalized and contextual notifications of content releases to users of the content sharing platform 120, the mobile platform 150, the social network platform 160, and/or any other platform. In one implementation, the notification component 140 can create an upcoming event pertaining to a content item responsive to a request to create the upcoming event initiated by a user (also referred to herein as “creator user”). In one example, the upcoming event may be and/or include publishing the content item (e.g., a video) at a future time. In another example, the upcoming event may be and/or include a live stream or broadcast of the content item at a future time.

The creator user may initiate a request to share information related to the upcoming event with one or more other users (e.g., by identifying the other users and/or providing an indication that the information is to be shared with the other users). Upon receiving the request, the notification component 140 can generate a preliminary notification of the upcoming event. The preliminary notification can include an indication that the content item is to be provided on the content sharing platform 120 or any other platform. In one example, the preliminary notification includes an indication that the content item is to be published on the content sharing platform 120 or any other platform. In another example, the preliminary notification includes an indication that the content item is to be streamed or broadcast via the content sharing platform 120 or any other platform.

The preliminary notification can include any information related to the upcoming event, such as a description of the upcoming event and/or the content item, scheduling information related to the upcoming event (e.g., a start time and/or an end time of the upcoming event), etc. The preliminary notification can include additional content such as text, images, graphics, and/or any other content. In some implementations, one or more portions of the additional content can be provided by the creator user.

The notification component 140 can cause the preliminary notification to be presented along with other content items related to the upcoming event (also referred to herein as “related content items”). For example, the related content items include videos and other content items provided on a channel of the creator user (e.g., a channel owned or curated by the creator user).

In one implementation, upon a viewing user initiating a playback of a related content item (e.g., by selecting a link directed to the related content item), the notification component 140 can cause the preliminary notification to be presented to the viewing user while providing playback of the related content item. In another example, the notification component 140 may present the preliminary notification to the viewing user as part of a user interface including information of the related content item and/or a channel of the creator user (e.g., a suggestions interface of what to watch next, an interface for presenting a channel's activity feed, etc.). In one implementation, while the playback of the video and/or the user interface is provided by a first client device (e.g., a television, a desktop computer, a laptop computer, etc.), the preliminary notification can be presented by a second client device (e.g., a mobile phone, a tablet computing device, a wearable computing device, etc.).

In some implementations, the notification component 140 can cause a follow-up notification of the upcoming event to be presented to the viewing user in response to receiving a request initiated by the viewing user for the follow-up notification. The follow-up notification can be presented by email, text message, mobile notification, account notification, etc. The follow-up notification can be presented to the viewing user at the start time of the upcoming event, at a data and/or time specified by the creator user or the viewing user, and/or at any other time. The follow-up notification can be presented via the content sharing platform 120, the mobile platform 150, the social network platform 160, and/or any other platform or service.

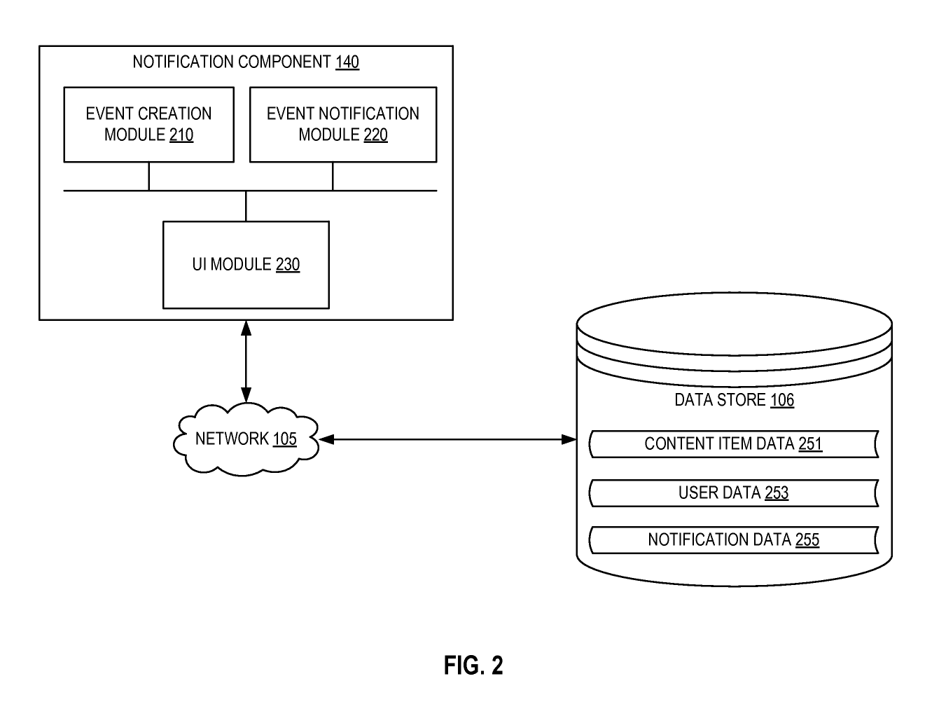

Further description of the notification component 140 and its specific functions is described in more detail below with respect to FIG. 2.

Although implementations of the disclosure are discussed in terms of content sharing platforms and promoting social network sharing of a content item on the content sharing platform, implementations may also be generally applied to any type of social network providing connections between users or to any type of content delivery platform providing content to end users. Implementations of the disclosure are not limited to content sharing platforms that provide channel subscriptions to users.

In situations in which the systems discussed here collect personal information about users, or may make use of personal information, the users may be provided with an opportunity to control whether the content sharing platform 120 collects user information (e.g., information about a user's social network, social actions or activities, profession, a user's preferences, or a user's current location), or to control whether and/or how to receive content from the content server that may be more relevant to the user. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the user and used by the content sharing platform 120, the server 130, the mobile platform 150, and/or any other component of the system 100.

FIG. 2 is a block diagram illustrating a notification component 140 and a data store 106 in accordance with one implementation of the disclosure. In one implementation, the notification component 140 includes an event creation module 210, an event notification module 220, a user interface (UI) module 230, and/or any other component for providing personalized and contextual event notifications. More or less components may be included in the notification component 140 without loss of generality. For example, two of the modules may be combined into a single module, or one of the modules may be divided into two or more modules. In one implementation, one or more of the modules may reside on different computing devices (e.g., different server computers). In one embodiment, the notification component and the data store of FIG. 2 may be the same as the notification component 140 and the data store 106 of FIG. 1, respectively.

The notification component 140 may be communicatively coupled to the data store 106. For example, the notification component 140 may be coupled to the data store 106 via a network (e.g., via network 105 as illustrated in FIG. 1). In another example, the data store 106 may be coupled directly to a server where the notification component 140 resides (e.g., may be directly coupled to server 130). The data store 106 may be a memory (e.g., random access memory), a cache, a drive (e.g., a hard drive), a flash drive, a database system, or another type of component or device capable of storing data. The data store 106 may also include multiple storage components (e.g., multiple drives or multiple databases) that may also span multiple computing devices (e.g., multiple server computers). The data store 106 includes content item data 251, user data 253, notification data 255, and/or any other data that can be used to provide personalized and contextual event notifications of content releases.

The content item data 251 may include information related to content items 121 of FIG. 1 and/or any other content item. For example, the content item data 251 may include information that can be used to provide playback of the content items 121 (e.g., video content, audio content, metadata, etc.). In another example, the content item data 251 may include identifying information related to the content items 121 (e.g. content identifiers, uniform resource identifiers (URIs), etc.). In a further example, the content item data 251 may include information related to notifications of upcoming events associated with one or more of the content items 121.

The user data 253 may include information related to users of a content sharing platform, such as the content sharing platform 120 of FIG. 1. For example, the user data 253 may include information pertaining to the users, such as user identifiers associated with the users. In another example, the user data 253 may include information related to user accounts associated with the users, such as account identifiers, identifiers of channels subscribed by the users, identifiers of channels owned or curated by the users, etc. In some implementations, a given user can be associated with one or more user accounts on one or more platforms (e.g., the content sharing platform 120, the mobile platform 150, the social network platform 160, etc.). In still another example, the user data 253 may include information related to channels associated with the users (e.g., channels on the content sharing platform 120 of FIG. 1), such as channel identifiers. In some implementations, a given user can be associated with one or more channels that provide content items.

In still another example, the user data 253 may include information related to one or more contacts of the users. As used herein, a contact of a given user may refer to a “friend,” a “follower,” a “subscriber,” a “connection,” a “phone contact,” and/or any other user that is connected to the given user via a content sharing platform, a mobile platform, a social network platform, an email service, a phone service, and/or any other platform or service.

In a further example, the user data 253 may include information related to user interactions with content items. Examples of user interactions with a content item include consuming (e.g., watching, reviewing, reading, etc.) the content item, subscribing to a channel associated with the content item, providing a comment in association with the content item (e.g., using a publicly-available comments section associated with the content item, using a social messaging platform, etc.), liking the content item, reviewing information related to the content item, sharing the content item, uploading the content item to a content sharing platform, etc.

The notification data 255 can include any information related to upcoming events pertaining to content items. In one example, the notification data 255 includes descriptions of the upcoming events, types of the upcoming events (e.g., a live stream or broadcast of video content, publishing a content item, etc.), scheduling information related to the upcoming events, etc. In another example, the notification data 255 includes information that can be used to provide one or more notifications of the upcoming events, such as information and/or content (e.g., images, text, video content, audio content, graphics, etc.) to be presented in association with the notifications. In still another example, the notification data 255 can include information related to one or more target users that are designated to receive one or more notifications of upcoming events, such as one or more user identifiers, channel identifiers, information describing the target user's interactions with content items, and/or any other information that can be used to identify the target users.

As described above, the notification component 140 can create an upcoming event pertaining to a content item and can provide personalized and contextual notifications of the upcoming event. For example, the event creation module 210 may create the upcoming event upon receiving a request to create the upcoming event from a computing device of a creator user (e.g., a client device 110A-Z of FIG. 1). In one implementation, the request can include a request to upload the content item (e.g., a video) to a content sharing platform and/or to schedule publishing the content item on the content sharing platform (e.g., the content sharing platform 120). In another implementation, the request can be and/or include a request to schedule live-streaming or live-broadcasting of the content item. The upcoming event can be provided (e.g., published, broadcast, streamed, etc.) on the content sharing platform 120, the mobile platform 150, the social network platform 160, and/or any other platform and/or service.

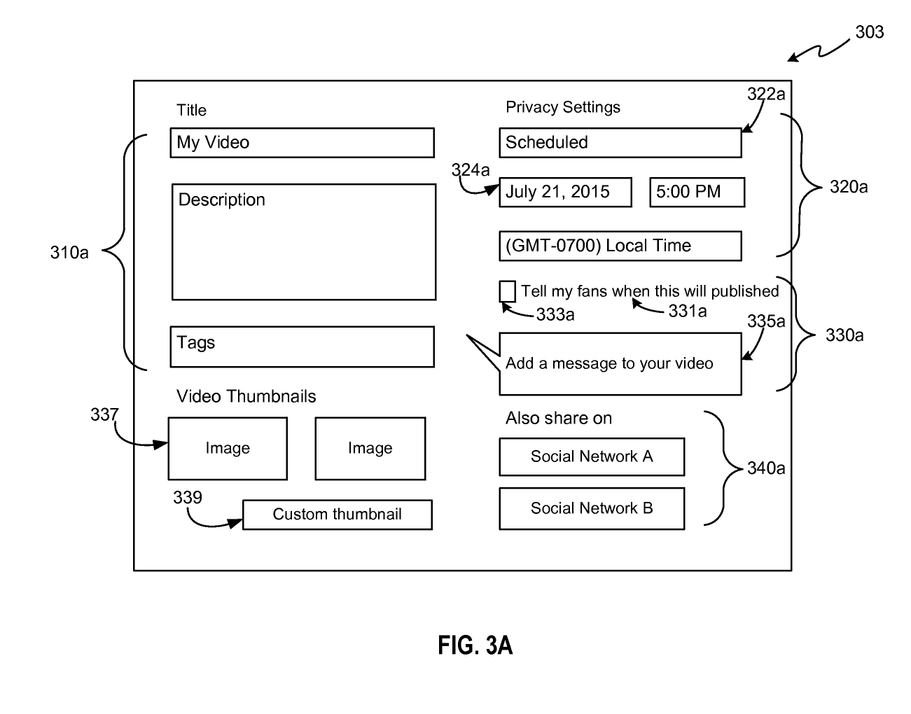

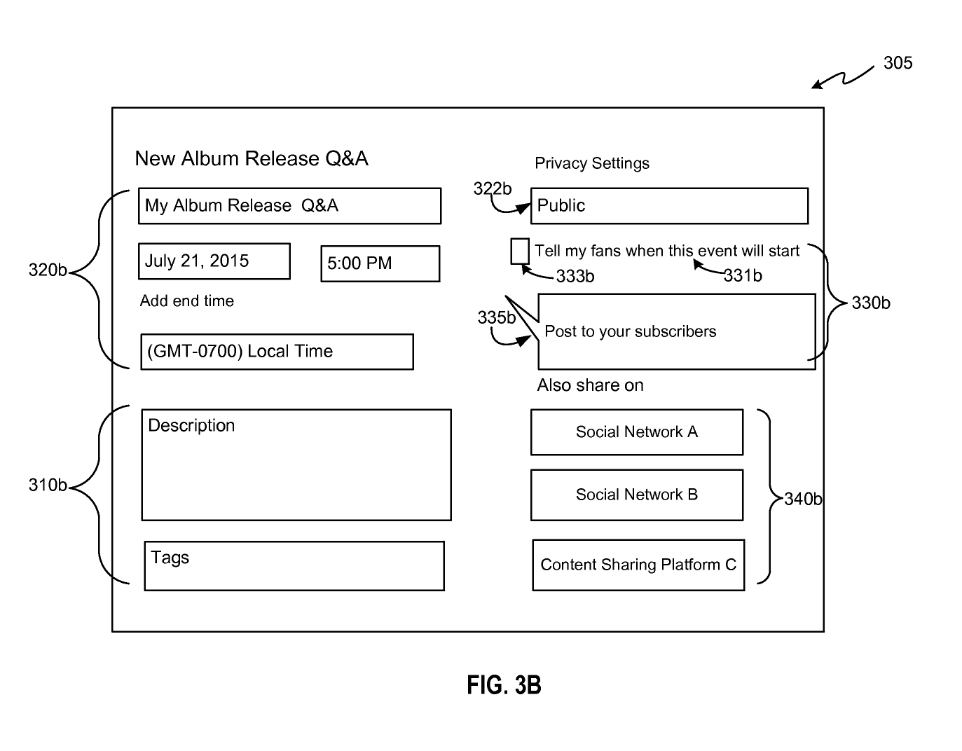

The event creation module 210 may provide a prompt to the creator user to share information related to the upcoming event with one or more other users. For example, the event creation module 210 can send, to the computing device, data for use to provide the prompt and/or to create the upcoming event. In one implementation, the prompt can be sent along with data for use to render one or more user interfaces, such as user interfaces 303 and 305 of FIGS. 3A and 3B.

The creator user may indicate that information related to the upcoming event is to be shared with one or more other users (e.g., by selecting checkboxes 333a-333b of FIGS. 3A-3B). In some implementations, the creator user may provide text, image content, audio content, video content, and/or any other content to be presented with a notification of the upcoming event.

The creator user may also identify one or more other users to share the information related to the upcoming event (also referred to herein as “target users”). In one implementation, the target users may include one or more users that are contacts of the creator user (e.g., subscribers of a channel associated with the creator user, followers of the creator user on a social network, etc.). In one example, the creator user may identify one or more channels to which the upcoming event may relate. The event notification module 220 may then identify users that interact with content of the channels (e.g., subscribers of the channels) as being target users. Additionally or alternatively, the event notification module 220 can automatically (without any input from the creator user) identify one or more channels associated with the creator user and can identify users interacting with the channels as being target users (e.g., based on the user data 253).

In another implementation, the target users may include one or more users that have particular interactions with content associated with the creator user (e.g., users who represent top fans of the creator user's content). The particular interactions can be determined by the creator user and/or the notification component 140. In one example, the particular interactions include a particular type of interaction with the content (e.g., consuming the content, subscribing to channels associated with the creator user, etc.). In another example, the particular interactions include a user interaction with content associated with the creator user during a particular time period (e.g., last week, last month, etc.). In still another example, the particular interactions include a user interaction with a predetermined amount of content associated with the creator user (e.g., a predetermined number of videos, a predetermine duration of videos, a predetermined number or duration of videos during a particular time period, etc.).

The event notification module 220 can generate an indication that information related to the upcoming event is to be presented to the other users. The event notification module 220 can also generate one or more notifications of the upcoming event. For example, the event notification module 220 can generate a preliminary notification of the upcoming event. The preliminary notification can include an indication that the content item is to be provided (e.g. published, streamed, broadcast, etc.) to the content sharing platform 120 or any other platform. The preliminary notification can include any information related to the upcoming event, such as scheduling information related to the upcoming event (e.g., a date and/or time of the upcoming event), a description of the upcoming event, etc. The information can be presented using any data, such as the data provided by the creator user.

The notification component 140 may store information related to the preliminary notification, such as data for use to present the preliminary notification, the indication that information related to the upcoming event is to be shared with one or more target users, information related to the target users, etc. The information related to the preliminary notification can be stored in association with information related to the creator user, such as identifying information of the creator user (e.g., one or more user identifiers), identifying information of one or more user accounts associated with the creator user (e.g., one or more account identifiers), identifying information of one or more channels associated with the creator user (e.g., one or more channel identifiers), etc. In some implementations, the information related to the preliminary notification can be stored in the data store 106.

The preliminary notification can be presented along with other content items related to the content item pertaining to the upcoming event (also referred to herein as “related content items”). In one example, a related content item can be a content item associated with the creator user, such as content items (e.g., videos, web pages, activity feeds, etc.) provided on one or more channels associated with the creator user, content items uploaded via one or more user accounts associated with the creator user, etc. In another example, a related content item and the content item pertaining to the upcoming event relate to the same or similar topics, genres, keywords, etc. In still another example, the creator user can designate one or more content items as related content items.

The notification component 140 can cause the preliminary notification to be presented in response to receiving a request pertaining to a related content item. In one example, the request pertaining to the related content item can be and/or include a request to present the related content item (e.g., playing back a video, rendering a web page, presenting a user interface, presenting an activity feed of a channel, etc.), a request to present information related to the related content item (e.g., presenting a user interface including information related to the related content item), and/or a request to perform any other action on the related content item.

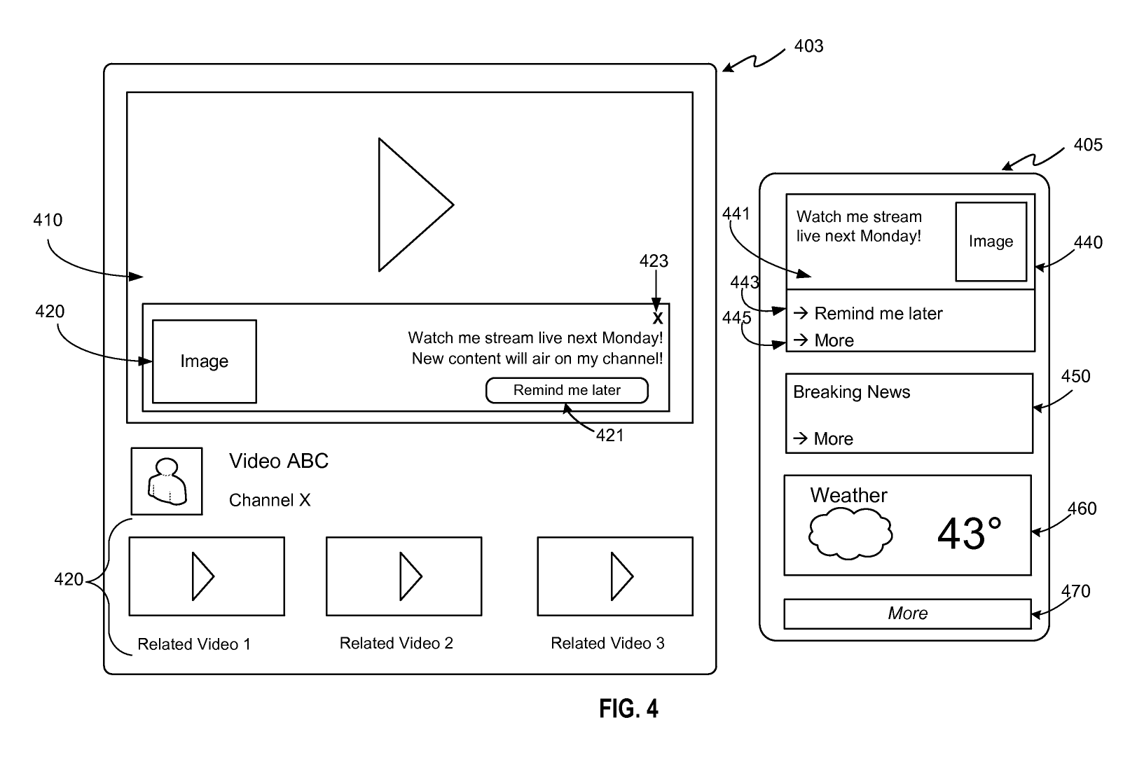

In one example, upon receiving a request to provide a playback of the related content item initiated by a viewing user, the UI module 230 may send, to a client device of the viewing user (e.g., a client 110A-Z of FIG. 1), data for use to present the preliminary notification and/or to perform the action on the related content item. In one implementation, the data can be sent along with data for use to render one or more user interfaces, such as a suggestions interface of what to watch next, a search interface for content items of the content sharing platform, a browsing interface for content items of the content sharing platform, a settings interface, a subscriptions interface, a playlist interface, a favorites interface, a history interface, etc. For example, as described in further detail below, user interfaces 403 and/or 405 of FIG. 4 can be used to present the preliminary notification.

In some implementations, the preliminary notification and the related content item can be presented on multiple client devices. For example, while a playback of the related content item is being provided on a first client device, the preliminary notification can be presented on a second client device (e.g., by presenting a user interface 405 of FIG. 4 or any other user interface).

In some implementations in which the preliminary notification is to be presented to one or more target users as described above, the notification module 220 can determine whether the viewing user is one of the target users. The notification module 220 can then cause the preliminary notification to be presented to the viewing user in response to determining that the viewing user is a target user.

In some implementations, the event notification module 220 can provide a prompt to the viewing user to receive one or more follow-up notifications of the upcoming event (e.g., by presenting one or more user interfaces using the UI module 230). In some implementations, the prompt can be provided in association with the preliminary notification. The event notification module 220 can cause a follow-up notification to be presented to the viewing user in response to receiving a request for the follow-up notification initiated by the viewing user. The follow-up notification can be presented to the viewing user at any suitable time, such as the start time of the upcoming event, a date and/or time specified by the creator user or the viewing user, etc.

The follow-up notification can be presented via the content sharing platform 120, the mobile platform 150, the social network platform 160, and/or any other suitable platform and/or service that can provide a notification of an event. The follow-up notification can be presented using any application, such as a calendar application, a messaging application, a content sharing and/or streaming application, a social network application, an email application, etc.

In some implementations, the event notification module 220 can present the viewing user with notifications of multiple upcoming events pertaining to content items (e.g., upcoming events associated with the creator users, upcoming events associated with one or more channels, upcoming events with particular start dates and/or time, etc.). The notifications can be presented to the viewing user as one or more preliminary notifications and/or follow-up notifications as described above. In one example, the event notification module 220 can generate a list of upcoming events related to a channel (e.g., videos to be published, streamed, or broadcast on the channel) and can present information related to the upcoming events using a calendar application, a media viewer, and/or any other application and/or service.

Some aspects of the functionality of the notification component 140 will be discussed in more detail below in conjunction with FIGS. 3-8.

FIGS. 3A and 3B illustrate examples of user interface 303 and 305 for creating an upcoming event pertaining to a content item in accordance with some implementations of the disclosed subject matter. User interface 303 can be used to schedule a content item (e.g., a video, a web page, etc.) to be published on a content sharing platform (e.g., the content sharing platform 120 of FIG. 1) and/or any other platform. User interface 305 can be used to create a live event pertaining to a content item (e.g., a live stream or broadcast of video content).

As illustrated, user interfaces 303 and 305 can include one or more user interface (UI) elements 310a-310b for prompting a creator user to provide information related to the content item. For example, UI elements 310a-310b may include one or more text boxes that can be used to enter a title, a description, one or more tags (e.g., keywords), and/or any other information related to the content item.

User interfaces 303 and 305 can also include one or more UI elements 320a-320b for prompting the creator user to provide information related to the upcoming event. In one example, the creator user can select a privacy setting for the content item and/or the upcoming event using privacy setting options 322a-322b. In one implementation, the user may indicate that the content item is scheduled to be published on the content sharing platform at a future time. In another implementation, the creator user may indicate that the content item is to be published on the content sharing platform immediately. In still another implementation, the creator user may indicate that information related to the content item may be provided to one or more other users identified by the creator user.

In another example, the creator user may provide scheduling information related to the upcoming event using UI elements 324a-324b. In one implementation, the creator user may provide a date, time, and time zone at which the upcoming event will start or end.

User interfaces 303 and 305 can include one or more UI elements 330a-330b for prompting the creator user to share information related to the upcoming event with one or more other users. In one example, user interface elements 330a-330b may include a message 331a-331b that prompts the creator user to notify one or more other users of the upcoming event. The creator user may select the message 331a-331b and/or a checkbox 333a-333b to indicate that information related to the upcoming event is to be shared with other users (e.g., other users that have subscribed to a channel of the creator user).

In another example, the creator user can provide text, images, video content, audio content and/or any other content to be presented with one or more notifications of the upcoming event. The creator user may enter text to be presented with the notification(s) using text boxes 335a-335b. The creator user may also select one or more images 337 or upload one or more images using UI element 339.

In still another example, the creator user may share information related to the upcoming event (e.g., a preliminary notification of the upcoming event, a link to the upcoming event, etc.) via one or more social network platforms, mobile platforms, and/or any other platform or service by selecting one or more UI elements 340a-340b corresponding to the platforms.

FIG. 4 illustrates examples of user interfaces 403 and 405 for providing personalized and contextual notifications of content releases in accordance with some implementations of the disclosed subject matter. In some implementations, user interfaces 403 and 405 may be presented on multiple computing devices. For example, while user interface 403 is being presented on a first computing device (e.g., a television, a desktop, etc.), user interface 405 can be presented on a second computing device (e.g., a mobile phone, a tablet computing device, a wearable computing device, etc.).

As illustrated, user interface 403 may include a content player 410 that can be used to present content items (e.g., a video provided on channel X). In some implementations, a content item can be presented along with information related to the content item, such as a title of the content item, a thumbnail image representative of the content item, and any other information related to the content item. The user interface 403 may also include a content recommendation portion 420 for presenting content related to the content item being presented using content player 410 (e.g., other videos available on channel X, content items having the same or similar topics, genres, keywords, etc.).

User interface 403 can also include a notification 420 of one or more upcoming events pertaining to content related to the content item being played back in media player 410. The notification 420 may include text, one or more images (e.g., a thumbnail), graphics, and/or any other content. The notification 420 may include an indication that the upcoming event(s) are to be provided at a particular time, on a particular platform, etc. The notification may also include an opt-in option 421 for prompting the viewing user to receive a follow-up notification of the upcoming event. In some implementations, the viewing user may select the opt-in option 421 to initiate a request for the follow-up notification of the upcoming event. The viewing user may also dismiss or minimize the notification 420 by selecting an indicator 423.

The notification 420 and the opt-in option 421 may be positioned in any suitable portion of user interface 403. The notification 420 and the opt-in option 421 may or may not overlap in some implementations. The notification 420 and the content player 410 may or may not overlap.

User interface 405 may include one or more recommendation portions 440, 450, and 460 for presenting information that might interest the viewing user. In one example, a notification 441 of the upcoming event may be presented in the recommendation portion 440. Notification 441 may include a message, an image, and/or any other information related to the upcoming event. The viewing user may select an option 443 to receive a follow-up notification of the upcoming event. The viewing user may also select an option 445 to view more information related to the upcoming event. Notification 441 may be presented in addition to or as an alternative to notification 420.

In some implementations, each of recommendation portions 440, 450, and 460 may be minimized and/or dismissed responsive to a user gesture (e.g., swiping in a given direction). Each of recommendation interfaces 440, 450, and 460 can be used to present text, images, video content, audio content, graphics, and/or any other content. The viewing user may view additional recommendation interfaces by selecting UI element 470.

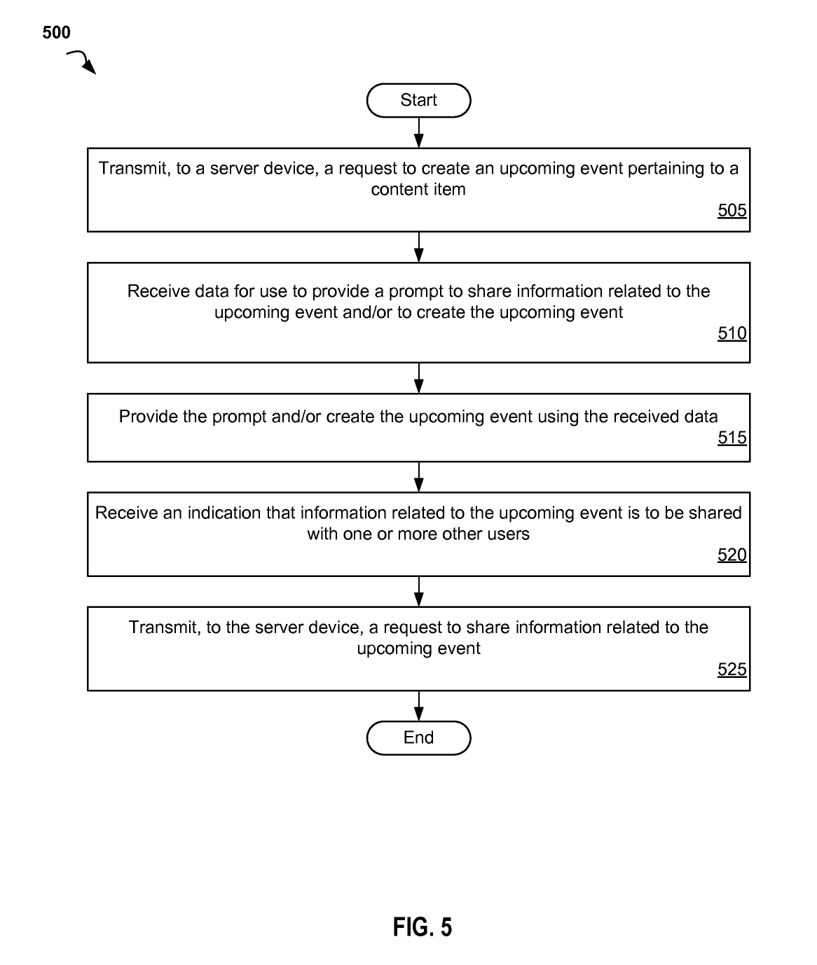

FIG. 5 is a flow diagram illustrating a client-side method 500 for facilitating the creation of an upcoming event pertaining to a content item, according to some implementations of the disclosure. The method 500 may be performed by processing logic that comprises hardware (e.g., circuitry, dedicated logic, programmable logic, microcode, etc.), software (e.g., instructions run on a processing device to perform hardware simulation), or a combination thereof.

For simplicity of explanation, the methods of this disclosure are depicted and described as a series of acts. However, acts in accordance with this disclosure can occur in various orders and/or concurrently, and with other acts not presented and described herein. Furthermore, not all illustrated acts may be required to implement the methods in accordance with the disclosed subject matter. In addition, those skilled in the art will understand and appreciate that the methods could alternatively be represented as a series of interrelated states via a state diagram or events. Additionally, it should be appreciated that the methods disclosed in this specification are capable of being stored on an article of manufacture to facilitate transporting and transferring such methods to computing devices. The term “article of manufacture,” as used herein, is intended to encompass a computer program accessible from any computer-readable device or storage media. In one implementation, method 500 may be performed by a client device (e.g., processing device executing a media viewer 111) as shown in FIGS. 1 and 2.

As illustrated, method 500 begins at block 505 when the processing device transmits, to a server device, a request to create an upcoming event pertaining to a content item. In some implementations, the request can be initiated by a creator user as described above in conjunction with FIGS. 1-4. In one example, the request can be and/or include a request to upload the content item to a content sharing platform and/or to schedule the content item to be published on the content sharing platform. In another example, the request can be for a live stream or broadcast of the content item.

At block 510, the processing device can receive data for use to create the upcoming event and/or to provide a prompt to share information related to the upcoming event. For example, the processing device receives data for presenting one or more user interfaces to facilitate the creator user's input related to the prompt.

At block 515, the processing device can provide the prompt associated with the upcoming event using the received data. The prompt can be provided by presenting video content, audio content, text, images, and/or any other content. For example, the prompt can be provided by presenting one or more user interfaces 303 and 305 as illustrated in FIGS. 3A and 3B.

At block 520, the processing device can receive an indication that information pertaining to the upcoming event is to be shared with one or more other users. The indication can correspond to any user input, such as a user selection of checkbox 333a-333b of FIGS. 3A-3B. The processing device can also receive information defining how the information pertaining to the upcoming event should be shared. For example, the information can identify content (e.g., specific channels or specific content items) related to the upcoming event that should be used for sharing the information pertaining to the upcoming event.

At block 525, the processing device can transmit, to the server device, a request to share information pertaining to the upcoming event. In one example, the request can include any information pertaining to the upcoming event, such as a description of the upcoming event and/or the content item, scheduling information related to the upcoming event, one or more tags associated with the upcoming event, etc. In another example, the request can include data to be presented with one or more notifications of the upcoming event, such as images, text, etc. provided by the creator user.

In still another example, the request can include information related to one or more platforms via which information related to the upcoming event is to be shared, such as a content sharing platform, a mobile platform, a social network platform, etc. In yet another example, the request can define how the information pertaining to the upcoming event should be shared (e.g., information identifying content such as specific channels or specific content items related to the upcoming event that should be used for sharing the information pertaining to the upcoming event). In a further example, the request can include one or more notification conditions that should be satisfied in order for the information related to the upcoming event to be shared (e.g., in the form of a notification). The notification condition can be a condition for identifying target users with which the information related to the upcoming event is to be shared, and can include user identifiers, information identifying one or more channels on a content sharing platform (e.g., channel identifiers), information describing user interactions by the target users, etc.

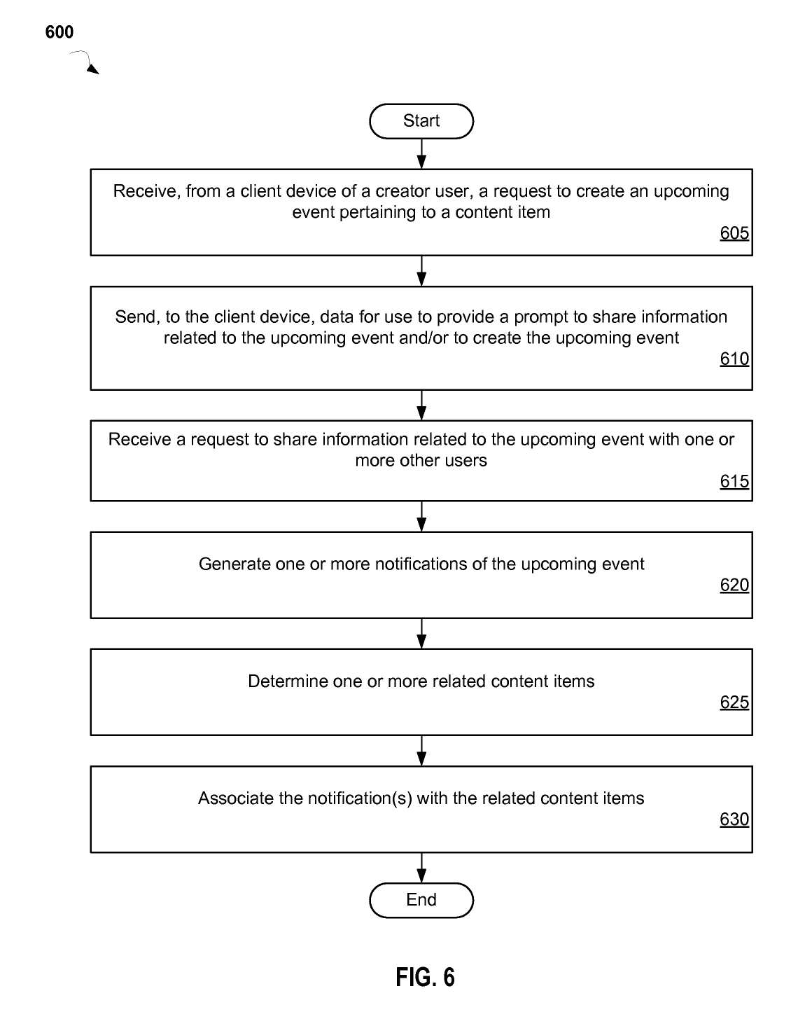

FIG. 6 is a flow diagram illustrating a server-side method 600 for creating an upcoming event pertaining to a content item, according to an implementation of the disclosure. The method 600 may be performed by processing logic that comprises hardware (e.g., circuitry, dedicated logic, programmable logic, microcode, etc.), software (e.g., instructions run on a processing device to perform hardware simulation), or a combination thereof. In one implementation, method 600 may be performed by a processing device executing the notification component 140 as shown in FIGS. 1 and 2.

As illustrated, method 600 begins at block 605 when the processing device receives, from a client device of a creator user, a request to create an upcoming event pertaining to a content item. The client device can be a client 110A-Z of FIG. 1. The request can be and/or include a request to create an upcoming event as described above in conjunction with block 505 of FIG. 5.

At block 610, the processing device can send data for use to provide a prompt to share information pertaining to the upcoming event. For example, the processing device sends data for rendering one or more user interfaces, such as user interfaces 303 and 305 of FIGS. 3A-3B.

At block 615, the processing device can receive a request to share information pertaining to the upcoming event with one or more users. The request can be and/or include a request to share information pertaining to an upcoming event as described above in conjunction with block 525 of FIG. 5. The request can include any information that can be used to share information pertaining to the upcoming event using one or more notifications. For example, the request can include information defining how the information pertaining to the upcoming event should be shared (e.g., information identifying content such as specific channels or specific content items related to the upcoming event that should be used for sharing the information pertaining to the upcoming event). As another example, the request can include information about one or more types of notifications to be provided (e.g., a video annotation, a text notification, etc.). As still another example, the request can include one or more notification conditions that should be satisfied in order for the information related to the upcoming event to be shared (e.g., in the form of a notification). As a further example, the request can include information that can be used to identify one or more target users to whom a notification of the event is to be provided. Based on the request, the processing device can create the upcoming event and store it (along with notification data) in a data store.

At block 620, the processing device can generate one or more notifications of the upcoming event based on the notification definition data and optionally store it in a data store. For example, the processing device can generate a preliminary notification of the upcoming event as described in connection with FIGS. 1-4. As another example, the processing device can generate one or more follow-up notifications that can be subsequently presented responsive to a user request. The follow-up notifications can also be stored in the data store.

At block 625, the processing device can determine one or more related content items. The related content items can include any content item that relates to the content item pertaining to the upcoming event. In one example, the related content items include one or more content items that are associated with the creator user (e.g., content items uploaded by the creator user to a content sharing platform, content items provided on one or more channels associated with the creator user, etc.). In still another example, a related content item and the content item pertaining to the upcoming event may have similar or the same content.

At block 630, the processing device can associate the notification(s) with the related content items. For example, the processing device stores information related to the notifications in association with information related to the related content items, such as content identifiers or other identifying information of the related content items, information related to the creator user (e.g., a user identifier, an account identifier, etc.), information related to one or more channels of the creator user (e.g., channel identifiers, etc.), etc.

In some implementations, one or more operations described in conjunction with FIG. 6 can be performed dynamically when the related content is presented based on notification data.

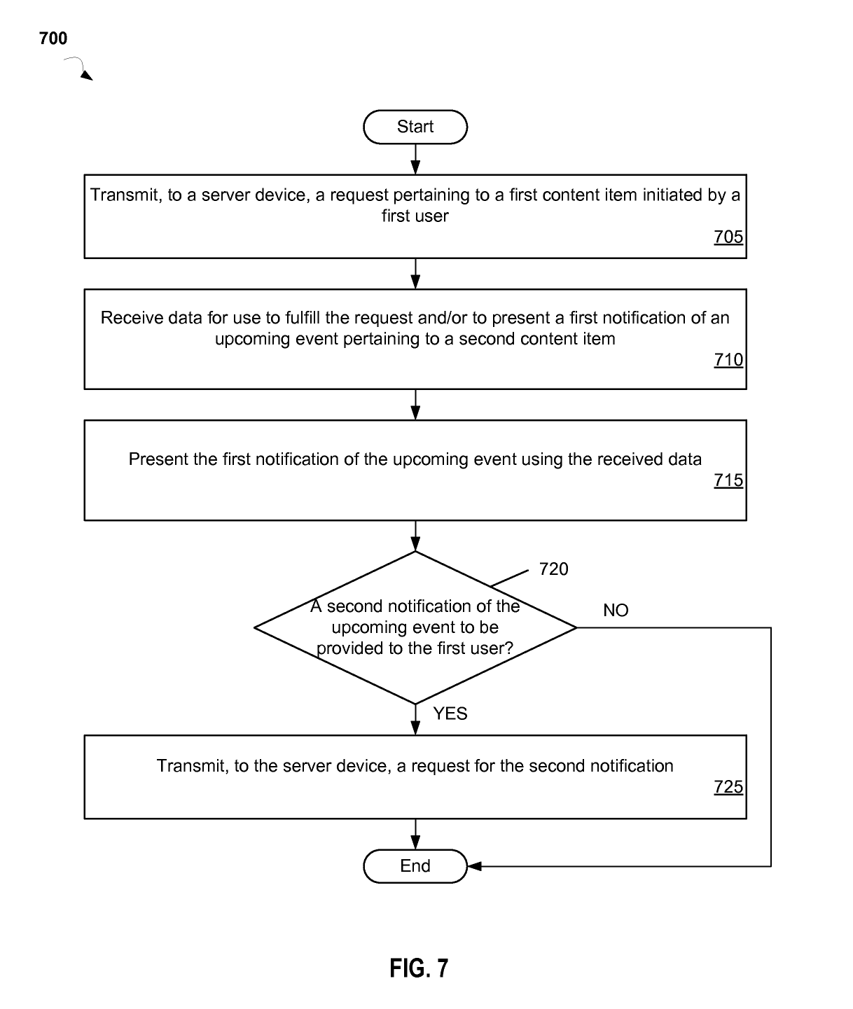

FIG. 7 is a flow diagram illustrating a client-side method 700 for providing personalized and contextual notifications of content releases, according to some implementations of the disclosure. The method 700 may be performed by processing logic that comprises hardware (e.g., circuitry, dedicated logic, programmable logic, microcode, etc.), software (e.g., instructions run on a processing device to perform hardware simulation), or a combination thereof. In one implementation, method 600 may be performed by a processing device executing a media viewer 111 as shown in FIGS. 1 and 2.

As illustrated, method 700 begins at block 705, when the processing device transmits, to a server device, a request pertaining to a first content item initiated by a first user. The first content item and the first user can be a related content item and a viewing user as described above in connection with FIGS. 1 and 2, respectively. The request can be and/or include a request to present information related to the first content item, a request to present the first content item, a request to subscribe to a channel associated with the first content item, etc.

At block 710, the processing device receives data for use to fulfill the request and/or to present a first notification of an upcoming event pertaining to a second content item. The first notification can be and/or include a preliminary notification as described above in conjunction with FIGS. 1 and 2. The first content item and the second content item can be related to a second user, such as the creator user as described above in conjunction with FIGS. 1 and 2.

At block 715, the processing device can present the first notification using the received data. In one example, the first notification can be presented using user interfaces 403 and/or 405 of FIG. 4.

In one implementation, the processing device can present the first content item and present the first notification on the same client device. In another implementation, the processing device can present the first content item on a first client device while causing the first notification to be presented on a second client device. For example, while the first content item is being presented (e.g., played back) on a television, the first notification can be presented on a mobile phone of the first user (e.g., using one or more recommendation interfaces as described above in conjunction with FIG. 4).

At block 720, the processing device determines whether it has received an indication that a second notification of the upcoming event is to be provided to the first user. The indication can correspond to any user input, such as a user selection of a portion of a user interface (e.g., option 421 and/or 443 of FIG. 4), a voice command, a gesture, etc.

In response to receiving the indication, the processing device can transmit, to the server device, a request for the second notification at block 725. Alternatively, the processing device can conclude method 700 in response to determining that the second notification is not to be provided to the first user.

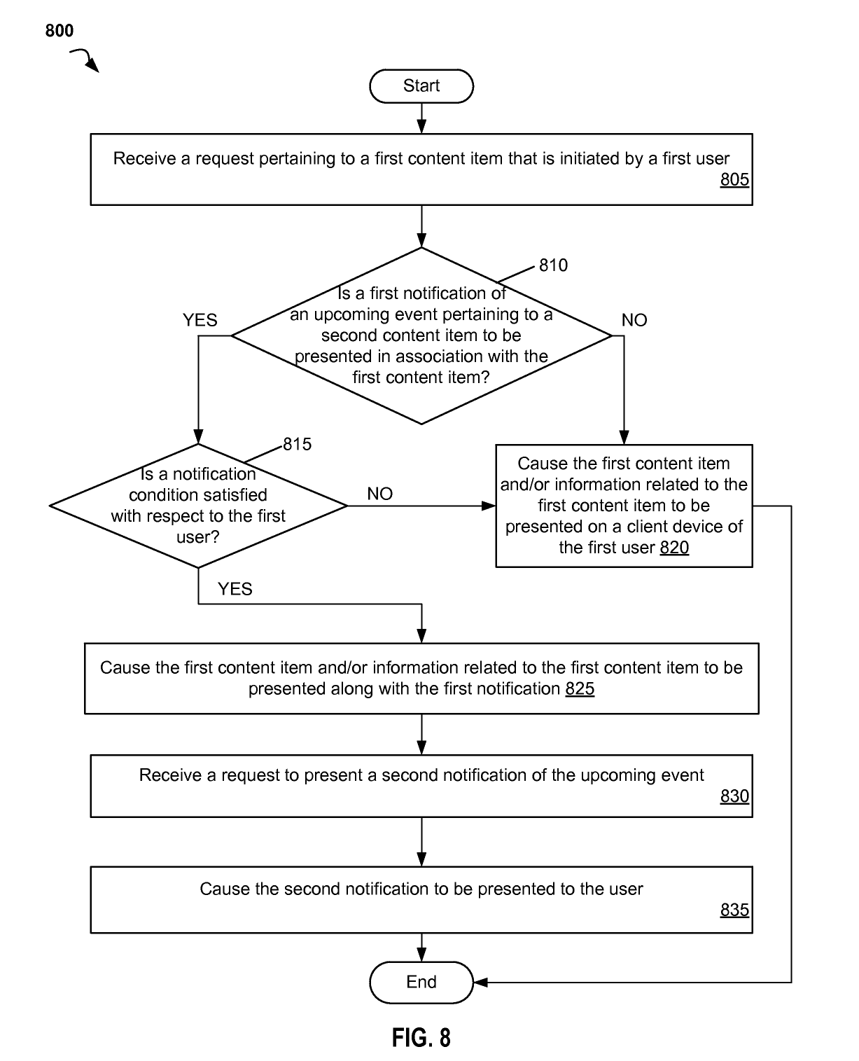

FIG. 8 is a flow diagram illustrating a server-side method 800 for providing personalized and contextual notifications of content releases. The method 800 may be performed by processing logic that comprises hardware (e.g., circuitry, dedicated logic, programmable logic, microcode, etc.), software (e.g., instructions run on a processing device to perform hardware simulation), or a combination thereof. In one implementation, method 800 may be performed by a processing device executing the notification component 140 as shown in FIGS. 1 and 2.

As illustrated, method 800 begins at 805 when the processing device receives a request pertaining to a first content item. In some implementations, the request is initiated by a first user, such as a viewing user as described above in connection with FIGS. 1-2. In one example, the request can be and/or include a request to present information related to the first content item, a request to provide playback of the first content item, a request to subscribe to a channel associated with the first content item, etc.

At block 810, the processing device can determine whether a first notification of an upcoming event pertaining to a second content item is to be presented in association with the first content item. In one example, the processing device determines whether a notification of an upcoming event pertaining to a content item is associated with the first content item. More particularly, for example, the processing device determines that the first notification is to be presented in association with the first content item in response to identifying the notification associated with the first content item.

In another example, the processing device identifies a second user associated with the first content item (e.g., using a user identifier, a content identifier, a channel identifier, etc. associated with the first content item). The processing device then determines whether the first notification is associated with the second user. Examples of the second user include an owner of a channel of a content sharing platform (e.g., the content sharing platform 120) that provides the first content item, a user that creates the first content item, a user that uploads the first content item to the content sharing platform, etc.

In still another example, the processing device identifies a channel and/or user account associated with the first content item. The processing device then determines whether the first notification is associated with the channel or user account. More particularly, for example, the processing device determines that the first notification is to be presented in association with the first content item in response to identifying the first notification associated with the channel or user account.

In some implementations, the processing device can proceed to block 815 and can determine whether a notification condition pertaining to the first notification is satisfied with respect to the first user. For example, the processing device can determine a notification condition associated with the first notification based on notification definition data of the first notification. The notification condition can be satisfied if the first user is a target user. In one implementation, the processing device determines one or more particular interactions with content associated with the second user by the target users (e.g., consuming a particular number of videos). The processing device then determines that the first user is one of the target users in response to determining that the first user has the interactions with the content associated with the second user. In another implementation, the processing device determines one or more channels associated with the second users. The processing device then determines that the first user is one of the target users in response to determining that the first user has subscribed to the one or more channels. In still another implementation, the processing identifies one or more target users designated by the second user and then determines whether the first user is one of the target users.

In some implementations, in response to determining that the first content item is not associated with the preliminary notification and/or that the notification condition associated with the first notification is not satisfied, the processing device can proceed to block 820 and can cause the first content item and/or information related to the first content item to be presented on a client device of the first user. For example, the processing device sends, to the client device, data for use to present the first content item and/or the related information (e.g., data for use to render one or more user interfaces).

In some implementations, in response to determining that the notification condition associated with the first notification is satisfied, the processing device can proceed to block 825 and can cause the first content item and/or information related to the first content item to be presented along with the first notification. For example, the processing device sends, to the client device, data for use to present the first notification, the related information, and/or the first notification. More particularly, for example, the processing device sends data for presenting one or more user interfaces, such as user interfaces 403 and 405 illustrated in FIG. 4.

In one implementation, the processing device can cause the first content item and/or information related to the first content item to be presented on a first client device and can cause the first notification to be presented on a second client device. For example, the processing device sends data for use to present the first content item and/or the related information to the first client device and sends data for use to present the first notification to the second client device. As another example, the processing device sends, to the first client device, data for use to present the first content item, the related information, and the first notification along with instructions to present the first notification on the second client device.

At block 830, the processing device can receive a request to present a second notification of the upcoming event. In one example, the second notification can be a follow-up notification of the upcoming event as described above in conjunction with FIGS. 1-2.

At block 835, the processing device can cause the second notification to be presented to the user. The second notification can be and/or include a follow-up notification as described above in connection with FIGS. 1-2. The second notification can be presented by email, text message, mobile notification, account notification, etc.

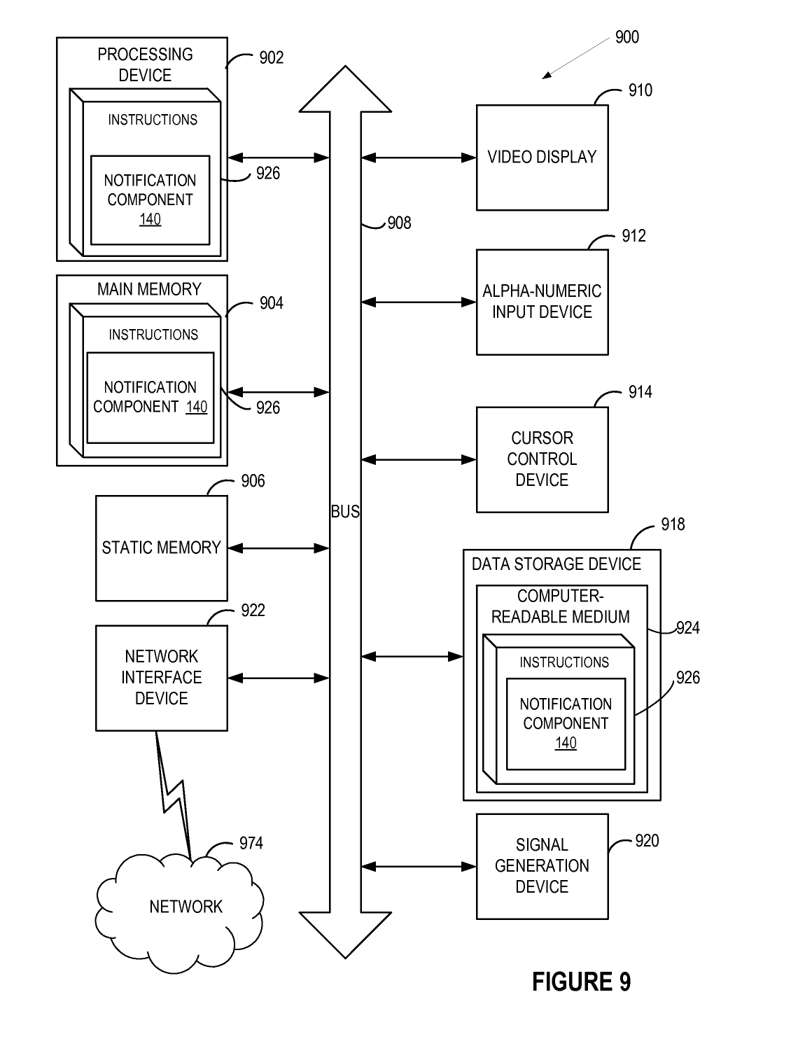

FIG. 9 illustrates a diagrammatic representation of a machine in the exemplary form of a computer system 900 within which a set of instructions, for causing the machine to perform any one or more of the methodologies discussed herein, may be executed. In alternative implementations, the machine may be connected (e.g., networked) to other machines in a LAN, an intranet, an extranet, or the Internet. The machine may operate in the capacity of a server or a client machine in client-server network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system 900 includes a processing device (processor) 902, a main memory 904 (e.g., read-only memory (ROM), flash memory, dynamic random access memory (DRAM) such as synchronous DRAM (SDRAM) or Rambus DRAM (RDRAM), etc.), a static memory 906 (e.g., flash memory, static random access memory (SRAM), etc.), and a data storage device 918, which communicate with each other via a bus 908.

Processing device 902 represents one or more general-purpose processing devices such as a microprocessor, central processing unit, or the like. More particularly, the processing device 902 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 902 may also be one or more special-purpose processing devices such as an application specific integrated circuit (ASIC), a field programmable gate array (FPGA), a digital signal processor (DSP), network processor, or the like. The processing device 902 is configured to execute instructions 926 for performing the operations and steps discussed herein.

The computer system 900 may further include a network interface device 922. The computer system 900 also may include a video display unit 910 (e.g., a liquid crystal display (LCD), a cathode ray tube (CRT), or a touch screen), an alphanumeric input device 912 (e.g., a keyboard), a cursor control device 914 (e.g., a mouse), and a signal generation device 920 (e.g., a speaker).

The data storage device 918 may include a computer-readable storage medium 924 on which is stored one or more sets of instructions 926 (e.g., software) embodying any one or more of the methodologies or functions described herein. The instructions 926 may also reside, completely or at least partially, within the main memory 904 and/or within the processing device 902 during execution thereof by the computer system 800, the main memory 904 and the processing device 902 also constituting computer-readable storage media. The instructions 926 may further be transmitted or received over a network 974 via the network interface device 922.

In one embodiment, the instructions 926 include instructions for implementing a notification component 140 as described with respect to FIGS. 1 and 2, and/or a software library containing methods that provide a dynamic size-adjustable content item player for a content sharing platform. While the computer-readable storage medium 924 is shown in an exemplary implementation to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing, encoding or carrying a set of instructions for execution by the machine and that cause the machine to perform any one or more of the methodologies of the present disclosure. The term “computer-readable storage medium” shall accordingly be taken to include, but not be limited to, solid-state memories, optical media, and magnetic media.

In the foregoing description, numerous details are set forth. It will be apparent, however, to one of ordinary skill in the art having the benefit of this disclosure, that the present disclosure may be practiced without these specific details. In some instances, well-known structures and devices are shown in block diagram form, rather than in detail, in order to avoid obscuring the present disclosure.

Some portions of the detailed description have been presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “receiving,” “sending,” “determining,” “identifying,” “presenting,” “generating,” “associating,” “storing,” or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

The disclosure also relates to an apparatus for performing the operations herein. This apparatus may be specially constructed for the required purposes, or it may include a general purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions.

The words “example” or “exemplary” are used herein to mean serving as an example, instance, or illustration. Any aspect or design described herein as “example’ or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an embodiment” or “one embodiment” or “an implementation” or “one implementation” throughout is not intended to mean the same embodiment or implementation unless described as such.

Reference throughout this specification to “one embodiment” or “an embodiment” means that a particular feature, structure, or characteristic described in connection with the embodiment is included in at least one embodiment. Thus, the appearances of the phrase “in one embodiment” or “in an embodiment” in various places throughout this specification are not necessarily all referring to the same embodiment. In addition, the term “or” is intended to mean an inclusive “or” rather than an exclusive “or.”

It is to be understood that the above description is intended to be illustrative, and not restrictive. Many other embodiments will be apparent to those of skill in the art upon reading and understanding the above description. The scope of the disclosure should, therefore, be determined with reference to the appended claims, along with the full scope of equivalents to which such claims are entitled.

What is claimed is:

1. A method, comprising:
receiving a request pertaining to a first content item, wherein the request is initiated by a first user;
determining, using a processing device, whether the first content item is associated with a first notification of an upcoming event pertaining to a second content item, wherein the second content item is to be provided by a second user;
causing the first notification to be presented to the first user in response to determining that the first content item is associated with the first notification, wherein the first notification is to inform the first user that the second content item is to be provided on a content sharing platform;
receiving, during a presentation of the first notification to the first user, a request initiated by the first user for a second notification of the upcoming event; and
causing the second notification of the upcoming event to be presented to the first user at a later time.

2. The method of claim 1, wherein the upcoming event comprises a live stream of the second content item on the content sharing platform.

3. The method of claim 1, wherein the upcoming event comprises publishing the second content item on the content sharing platform.

4. The method of claim 1, wherein the request pertaining to the first content item comprises a request to present the first content item, and wherein causing the first notification to be presented to the first user comprises:
causing the first content item to be presented on a first client device; and
causing the first notification to be presented on a second client device.

5. The method of claim 4, wherein the request pertaining to the first content item comprises a request to present information related to the first content item.

6. The method of claim 1, further comprising:
in response to determining that the first content item is associated with the first notification, determining whether a notification condition pertaining to the first notification is satisfied with respect to the first user, wherein the first notification is to be presented to the first user in response to determining that the notification condition pertaining to the first notification is satisfied with respect to the first user.

7. The method of claim 6, wherein determining whether the notification condition pertaining to the first notification is satisfied with respect to the first user comprises determining whether the first user has a predetermined interaction with content provided by the second user.

8. The method of claim 6, wherein determining whether the notification condition pertaining to the first notification is satisfied with respect to the first user comprises determining whether the first user has subscribed to a channel associated with the second user.

9. The method of claim 1, further comprising:
generating the first notification in response to receiving a request to share information related to the upcoming event; and
associating the first notification with the first content item in response to determining that the first content item relates to the second content item.

10. A system comprising:
a memory; and
a processing device communicatively coupled to the memory, the processing device to:
receive a request pertaining to a first content item, wherein the request is initiated by a first user;
determine whether the first content item is associated with a first notification of an upcoming event pertaining to a second content item, wherein the second content item is to be provided by a second user;
cause the first notification to be presented to the first user in response to determining that the first content item is associated with the first notification, wherein the first notification is to inform the first user that the second content item is to be provided on a content sharing platform;
receive, during a presentation of the first notification to the first user, a request initiated by the first user for a second notification of the upcoming event; and
cause the second notification of the upcoming event to be presented to the first user at a later time.

11. The system of claim 10, wherein the upcoming event comprises a live stream of the second content item on the content sharing platform.

12. The system of claim 10, wherein the upcoming event comprises publishing the second content item on the content sharing platform.

13. The system of claim 10, wherein the request pertaining to the first content item comprises a request to present the first content item, and wherein to cause the first notification to be presented to the first user, the processing device is further to:
cause the first content item to be presented on a first client device; and
cause the first notification to be presented on a second client device.

14. The system of claim 13, wherein the request pertaining to the first content item comprises a request to present information related to the first content item.

15. The system of claim 10, wherein the processing device is further to:
in response to determining that the first content item is associated with the first notification, determine whether a notification condition pertaining to the first notification is satisfied with respect to the first user, wherein the first notification is to be presented to the first user in response to determining that the notification condition pertaining to the first notification is satisfied with respect to the first user.

16. A non-transitory machine-readable storage medium storing instructions which, when executed, cause a processing device to:
receive a request pertaining to a first content item, wherein the request is initiated by a first user;
determine, by the processing device, whether the first content item is associated with a first notification of an upcoming event pertaining to a second content item, wherein the second content item is to be provided by a second user;
cause the first notification to be presented to the first user in response to determining that the first content item is associated with the first notification i, wherein the first notification is to inform the first user that the second content item is to be provided on a content sharing platform;
receive, during a presentation of the first notification to the first user, a request initiated by the first user for a second notification of the upcoming event; and
cause the second notification of the upcoming event to be presented to the first user at a later time.

17. The non-transitory machine-readable storage medium of claim 16, wherein the upcoming event comprises a live stream of the second content item on the content sharing platform.

18. The non-transitory machine-readable storage medium of claim 16, wherein the upcoming event comprises publishing the second content item on the content sharing platform.

19. The non-transitory machine-readable storage medium of claim 16, wherein the request pertaining to the first content item comprises a request to present the first content item, and wherein to cause the first notification to be presented to the first user, the processing device is further to:
cause the first content item to be presented on a first client device; and
cause the first notification to be presented on a second client device.

20. The non-transitory machine-readable storage medium of claim 16, wherein the processing device is further to:
in response to determining that the first content item is associated with the first notification, determine whether a notification condition pertaining to the first notification is satisfied with respect to the first user, wherein the first notification is to be presented to the first user in response to determining that the notification condition pertaining to the first notification is satisfied with respect to the first user.
